(19) United States
(12) Patent Application Publication
(10) Pub. No.: US 2008/0115723 A1
(43) Pub. Date: May 22, 2008

(54) Top-feed vehicle tire dressing applicator

(75) Inventor: James M. Coates, Girard, OH (US)

Correspondence Address: MCCORMICK, PAULDING & HUBER LLP, CITY PLACE II, 185 ASYLUM STREET, HARTFORD, CT, 06103, US

(73) Assignee: SIMONIZ USA, Inc., Bolton, CT (US)

(21) Appl. No.: 11/602,746

(22) Filed: Nov. 21, 2006

(51) Int. Cl. B05C 1/06

(52) U.S. Cl. 118/205

(57) ABSTRACT

An improved apparatus for applying fluid to a tire of a vehicle having an applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from the tire, the improvement including a manifold for dispensing fluid to the applicator pad, the manifold being disposed proximate an upper surface of the applicator pad and having a plurality of discharge ports for dispensing fluid onto the applicator pad, such that, during use of the apparatus, fluid from the ports contacts the upper surface of the applicator pad and flows through the applicator pad due to the force of gravity.

### FIELD OF THE INVENTION

This invention pertains generally to apparatus for applying a fluid to the tires of a vehicle being conveyed within an automatic vehicle washing facility, and more particularly, to an apparatus having a top-feed fluid dispenser for applying a dressing or other fluid to an applicator pad for application on the tires of a vehicle.

### BACKGROUND OF THE INVENTION

One apparatus for applying a tire dressing to the tires of a vehicle is shown in U.S. Pat. No. 6,461,429 issued Oct. 8, 2002 to William Gorra (referred to hereinafter as “the '429 patent”). The '429 patent and the present application are commonly owned.

The patented apparatus includes left and right dressing applicators positionable adjacent a vehicle conveying track of the type typically used in a car wash facility. Each of the dressing applicators includes applicator pads mounted to a frame member for movement between an engaged position, wherein a contact surface of the applicator pad engages a sidewall of a tire for applying a fluid to the sidewall, and a disengaged position, wherein the contact surface is spaced apart from the tire.

The applicator pads disclosed in the '429 patent each define a plurality of orifices extending into a rear portion of the applicator pads along a longitudinal center line of the applicator pad. The orifices are in fluid communication with the contact surface of the applicator pad via a porous foam material of the applicator pad. A spray nozzle partially extends into each of the orifices for dispensing fluid to the applicator pad. The fluid dispensed from the spray nozzle is typically delivered in a conical spray into the orifice and absorbed by the porous applicator pad where the fluid remains until the contact surface is engaged with a sidewall of a tire for applying the fluid to the sidewall.

In the apparatus of the '429 patent, the fluid delivered to the orifices via the spray nozzles is spread through the applicator pad to an upper portion of the pad and an upper portion of the contact surface via capillary action. Thus, during use of the apparatus, fluid sprayed into the orifices must rely on capillary action to reach the upper portion of the applicator pads and the contact surface. If the capillaries are obstructed by dirt or ice, the upper portions of the applicator pads are not effectively saturated for storing fluid and/or applying the same to the sidewalls of the tires.

Also in the patented apparatus, the foam applicator pads each define a plurality of orifices formed in the rear side of the pads for receiving the spray nozzles, and the orifices must be formed in the pad especially for use with the patented apparatus so that the orifices are alignable with the spray nozzles when the pad is mounted on the apparatus. During use of the apparatus, the applicator pads engage the sidewalls of the tires for applying a dressing to the sidewalls and consequently become worn over time and must be replaced periodically. Accordingly, the required orifices formed in the applicator pads make the applicator pads more expensive to manufacture and thus increase the overall operating cost of the apparatus.

Based on the foregoing, it is the general object of the present invention to provide a vehicle tire dressing or other fluid applicator that overcomes the problems and drawbacks of prior art systems.

### SUMMARY OF THE INVENTION

The present invention provides an improved apparatus for applying fluid to a tire of a vehicle having an applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from the tire. The improvement includes a manifold for dispensing fluid to the top of the applicator pad, the manifold being disposed proximate an upper surface of the applicator pad and having a plurality of discharge ports for dispensing fluid onto the applicator pad, such that, during use of the apparatus, fluid from the ports is applied to the upper surface of the applicator pad and flows downwardly through the applicator pad due to the force of gravity.

In one embodiment of the present invention, a top-feed fluid dispenser includes a top plate coupled to the frame member, the top plate defining an edge disposed adjacent a length of the upper surface of the applicator pad and having a manifold coupled to the top plate near the edge thereof such that fluid dispensed from the manifold is applied to the upper surface of the applicator pad.

In another aspect, the present invention comprises a kit for modifying an apparatus for applying fluid to a tire of a vehicle of the type having an elongated applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from said tire. The kit includes a top plate attachable to the frame member such that at least a portion thereof overlies the applicator pad when the apparatus is positioned for use thereof, and a manifold connectable to a fluid supply for dispensing fluid to the applicator pad. The manifold is attachable to the top plate proximate an upper surface of the applicator pad such that, during use of the apparatus, fluid dispensed through the manifold is applied to the upper surface of the applicator pad and flows downwardly through the applicator pad due to the force of gravity.

One advantage of the present invention tire dressing applicator is that the manifold disposed proximate an upper surface of the applicator pad allows the applicator pad to be more efficiently utilized in that the maximum amount of fluid that the applicator pad can absorb in the porous foam material thereof can be delivered to the applicator pad via the top-feed dispenser and transferred through a height of the pad due to the force of gravity.

Another advantage of the present invention is that the applicator pads do not require orifices for receiving nozzles and therefore the manufacture thereof does not require any special machining or molding required in the prior art pads.

Another advantage of the present invention tire dressing applicator is that the relatively simple design of the top-feed fluid dispenser including the manifold and top plate of the present invention provides a fluid dispenser that is less expensive to manufacture than the nozzle assembly of the prior art apparatus.

A further advantage of the present invention tire dressing applicator is that the top-feed fluid dispenser is arranged such that the fluid ports of the manifold are exposed and visible during operation of the apparatus such that one can quickly determine by looking at the manifold whether or not the manifold is working and that fluid is being dispensed from each of the ports thereof.

These and other objects, features and advantages of the present invention will become more apparent in view of the following detailed description and accompanying drawings.

### BRIEF DESCRIPTION OF THE DRAWINGS

FIG. 1 is a schematic plan view of one embodiment of a tire dressing apparatus according to the present invention shown in a car wash facility with a vehicle approaching the apparatus.

FIG. 2 is a perspective view of another embodiment of a tire dressing apparatus according to the present invention shown with the applicator pads and the top-feed fluid dispenser removed.

FIG. 3 is a partial cross-sectional view of a left side applicator in accordance with the present invention including a top-feed fluid dispenser and applicator pad mounted to the frame member.

FIG. 4 is a perspective view of a top-feed fluid dispenser in accordance with the present invention.

FIG. 5 is an enlarged partial perspective view of the top-feed fluid dispenser of FIG. 4.

FIG. 6 is a perspective view of a top plate of the top-feed fluid dispenser of FIG. 4 without the manifold.

FIG. 7 is a perspective view of the manifold of the top-feed fluid dispenser of FIG. 4.

FIG. 8 is a perspective view of a clamp for securing the manifold to the top plate of the dispenser.

### DETAILED DESCRIPTION OF PREFERRED EMBODIMENTS

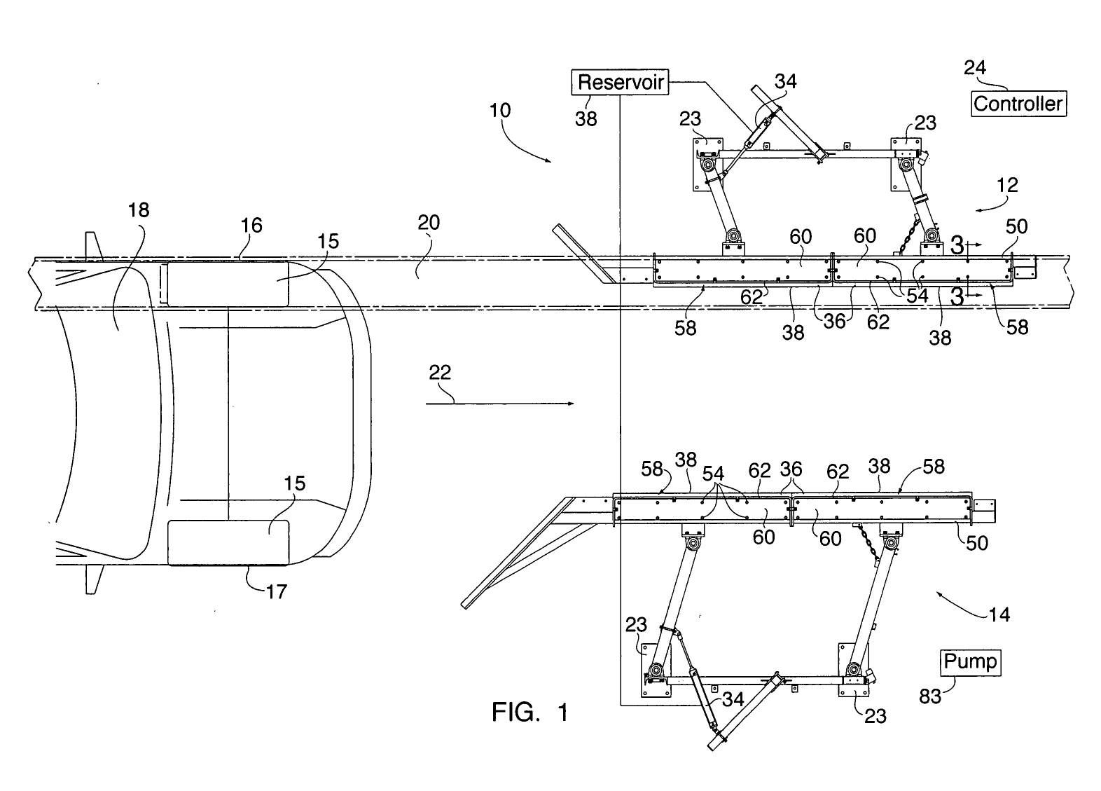

Referring to FIG. 1, one embodiment of a tire dressing apparatus in accordance with the present invention is generally referred to by the reference number 10. The tire dressing apparatus 10 includes left and right applicators 12 and 14 respectively, shown positioned adjacent a track 20 of a vehicle washing facility (not shown). A vehicle 18 is shown being conveyed along the track 20 in a direction 22 toward the tire dressing apparatus 10. The track 20 includes standard conveying equipment for moving a vehicle through a vehicle washing facility which is well known in the art. The tire dressing apparatus 10 includes a plurality of floor mounts 23 which are used to secure the left and right applicators 12, 14 to the floor of the vehicle washing facility and to level the apparatus.

The left and right applicators 12, 14 are controlled by a controller 24 of the washing facility to apply a fluid to the sidewalls 16, 17 of the tires 15 on the left and right sides of the vehicle 18 respectively. The left applicator 12 is operable to apply fluid to the sidewalls 16 of the tires 15 on the left side of the vehicle 18 and the right applicator 14 is operable to simultaneously apply fluid to the sidewalls 17 of the tires on the right side of the vehicle. Each of the left and right applicators 12, 14 are movable via extendable cylinders 34 between an engaged position, wherein the applicator pads 36 engage the sidewalls 16, 17 on each of the left and right sides of the vehicle 18 respectively, and a disengaged position, wherein the applicator pads are spaced apart from the tires. In the FIG. 1 embodiment, the cylinders 34 are hydraulic and connected to a hydraulic fluid reservoir 38 and controlled to extend and retract in length in response to commands from the controller 24.

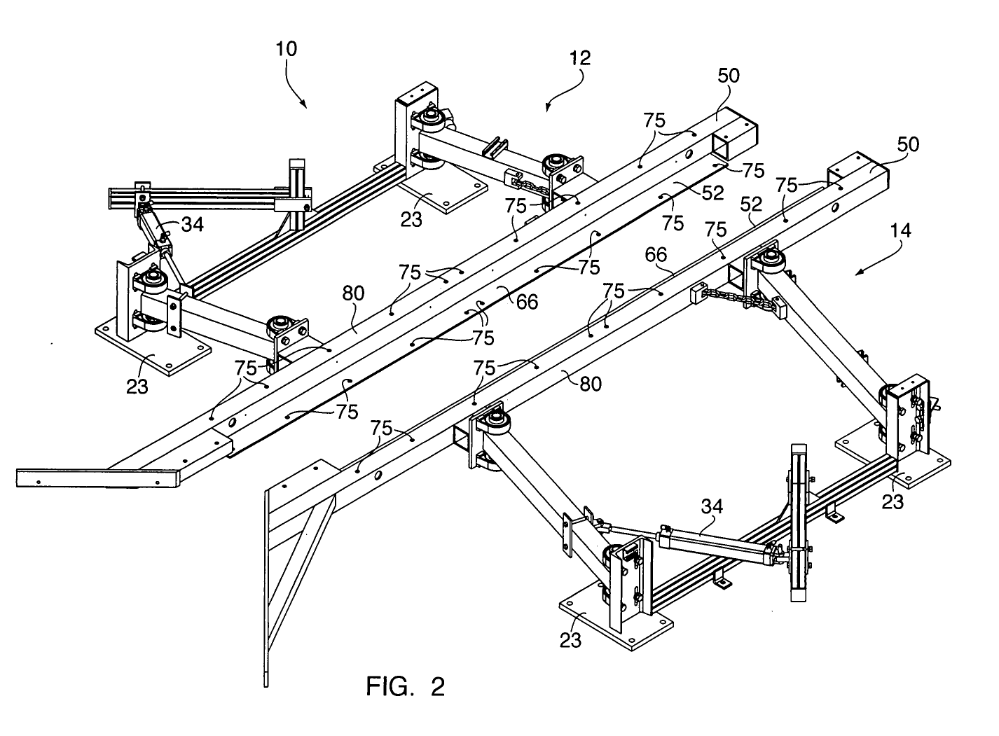

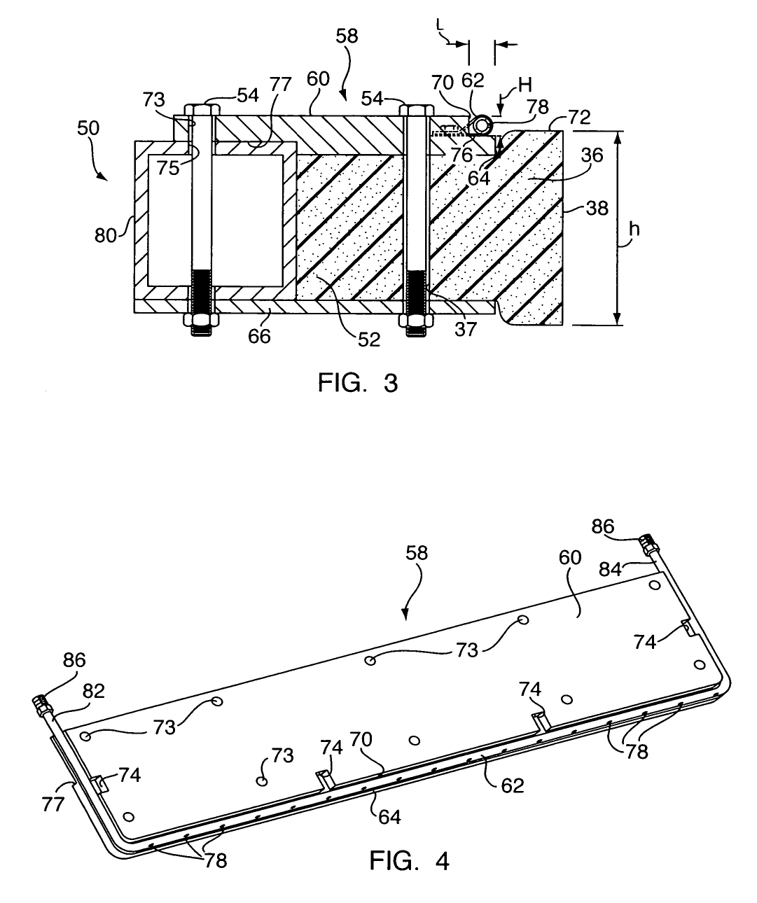

Referring to FIGS. 2 and 3, the left and right applicators 12, 14 each include elongated frame members 50 which define elongated openings 52 for receiving the applicator pads 36. The applicator pads 36 are elongated pads preferrably formed of a porous foam material for retaining the tire dressing fluid therein. The applicator pads 36 having a normally rectangular cross-section. In a preferred embodiment, two applicator pads 36, 36 are positioned end-to-end in the opening 52 on each of the frame members 50 and secured thereto via bolts 54. The applicator pads 36 define bolt holes 37 for receiving the bolts 54 and attaching the pads to the frame members 50. For a more complete description of such an apparatus, reference may be had to U.S. Pat. No. 6,461,429 which is incorporated by reference herein in its entirety.

Referring to FIGS. 3-8, the tire dressing applicator 10 includes a top-feed fluid dispenser 58 having a top plate 60 and fluid manifold 62. As shown in FIG. 3, the top plate 60 mounts to the frame member 50 such that a forward edge 64 of the top plate overlies the applicator pad 36. The top plate 60 is secured to the frame member 50 via the bolts 54 with the applicator pad 36 compressed between the top plate and a lower support 66 of the frame member 50. The fluid manifold 62 is attached to the top plate 60 in a notch 70 defined by the forward edge 64 of the top plate for dispensing fluid to the upper surface 72 of the applicator pad 36.

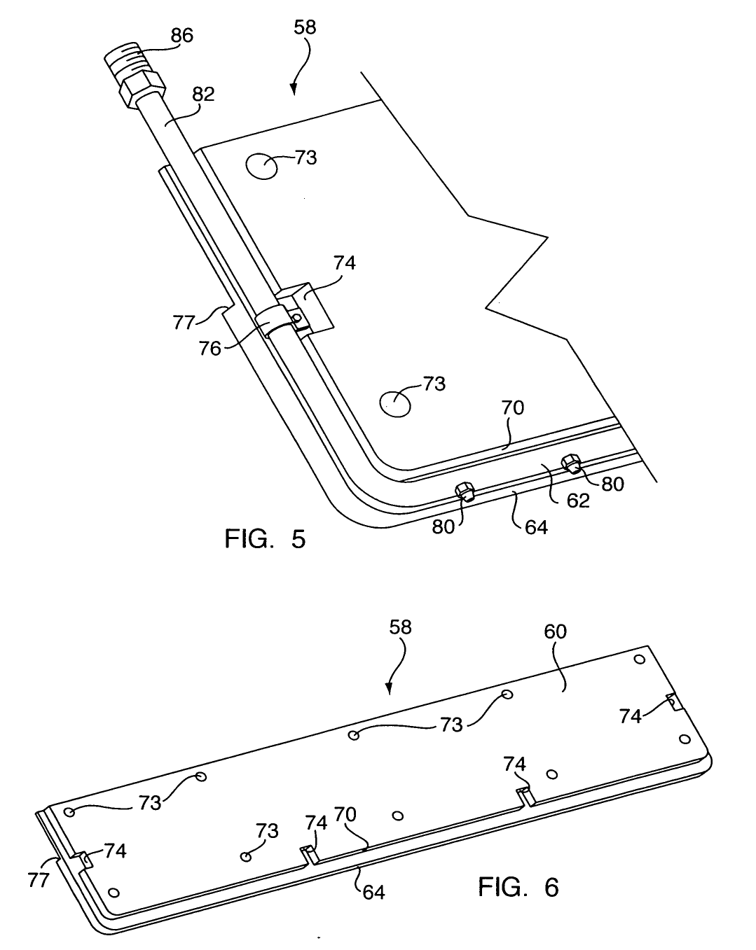

As shown in FIGS. 4 and 5, the top plate 60 defines holes 73 which are alignable with corresponding holes 75 in the frame member 50 (FIGS. 2 and 3) for receiving the bolts 54 and securing the top plate to the frame member. The top plate also defines a plurality of cut-outs 74 along the forward edge 64 thereof for receiving damps 76 (FIG. 8) or other fasteners for attaching the fluid manifold 62 to the top plate as shown in FIG. 5. A recess 77 (FIG. 3) formed in a lower surface of the top plate 60 receives a tube member 80 of the frame member 50 and cooperates with the forward edge 64 to provide a stepped lower surface of the top plate for compressing the applicator pad 36 between the top plate and the lower support 66 and securely mounting the applicator pad to the frame member 50.

Referring to FIGS. 2 and 4, in the illustrated embodiment, the top plate 60 is configured such that two applicator pads 36 and two top plates 60 are positionable end-to-end for attachment to the elongated frame members 50 of each of the left applicator and right applicators 12, 14, respectively. In other embodiments of the tire dressing applicator 10, other configurations of the applicator pads 36 and top plates 60 could be used, e.g., 3 applicator pads; and/or 3 top plates).

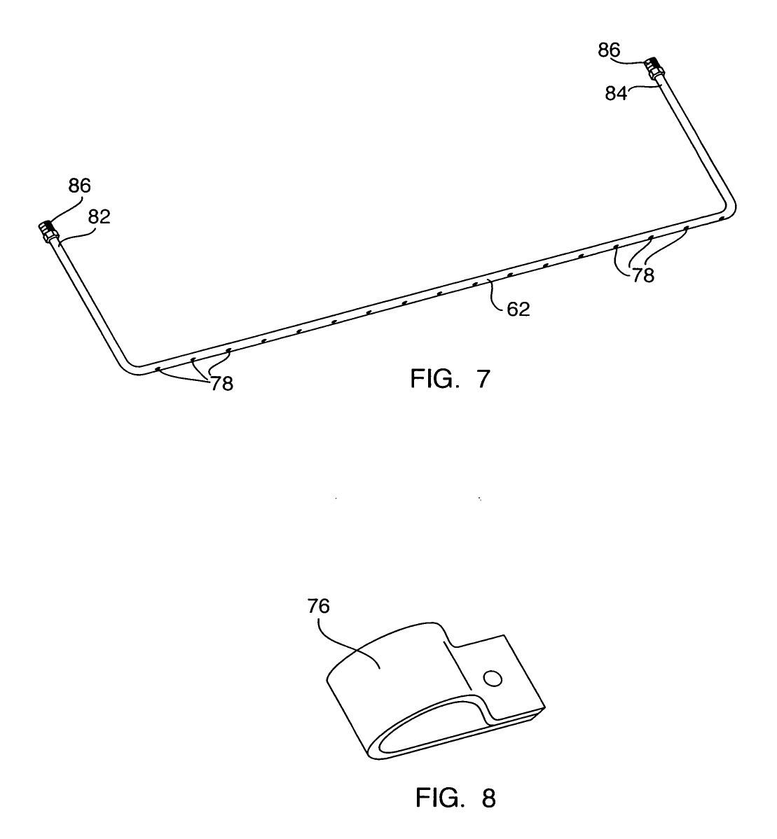

The top plate 60 defines a notch 70 formed in a forward edge of the plate for receiving the manifold 62. As shown in FIG. 3, in the illustrated embodiment, the notch 70 is formed such that a length L and height H of the notch are larger than the diameter of the manifold 62 so as prevent damage to the manifold in the event the top plate 60 comes in contact with a vehicle or other objects. The manifold 62 defines a plurality of ports 78 on a forward side thereof for dispensing a tire dressing or other fluid to the applicator pad 36. The ports 78 are located above the applicator pad 36 such that fluid discharged through the ports 78 is dispensed onto the upper surface 72 of the applicator pads 36. In a preferred embodiment of the present invention, the manifold 62 is formed of ⅜″ diameter steel tubing having a plurality of 1/16″ diameter holes drilled in a forward side thereof forming the ports 78. In one embodiment of the invention, the ports 78 are spaced approximately six to seven inches apart along the length of the manifold. As shown in FIGS. 4 and 7, the manifold 62 includes an inlet 82 and outlet 84 at opposing ends thereof for connection, one each to a fluid supply reservoir (not shown), and a return line to the supply reservoir.

In a preferred embodiment, an air powered pump 83 (FIG. 1) such as a Flojet Model G-57V is used to deliver a tire dressing fluid to the manifold at an appropriate time relative to the position of a vehicle in the track 20 for dispensing the tire dressing fluid to the applicator pads 36. The air pressure to the pump 83 can be adjusted to control the projection of the fluid out of the ports 78 so that the fluid is dispensed to the upper surface of the 72 of the applicator pads 36 and does not squirt beyond the contact surface 38 thereof. In another embodiment of the invention, a nozzle 80 (FIG. 5) can be disposed in each of the ports 78 for preventing fluid from draining from the manifold 62. Referring still to FIG. 5, a fitting 86 is provided at the inlet 82 and/or outlet 84 of the manifold for coupling the manifold to the pump 83 or fluid supply lines (not shown).

Referring to FIG. 3, the top-feed fluid dispenser 58 is mounted to the frame member 50 such that the manifold 62 including the outlet ports 78 is disposed above the upper surface 72 of the applicator pad 36. As set forth above, fluid delivered through the manifold 62 can be controlled via adjusting the air pressure to the pump 83 to reach the upper surface 72 of applicator pad 36. Upon reaching the upper surface 72 of the applicator pad 36, the fluid is absorbed and allowed to move downwardly through a height h of the applicator pad 36 due to the force of gravity. As the fluid moves through the applicator pad 36, the porous foam material of the applicator pad absorbs and retains the fluid until the contact surface 38 of the applicator pad engages the sidewalls 16, 17 of the tires 15 (FIG. 1). Positioning the manifold 62 above the applicator pad 36 allows the applicator pad to be efficiently utilized in that the maximum amount of fluid that the applicator pad can absorb in the porous foam thereof can be delivered to the applicator pad 36 via the top-feed dispenser and transferred through the height h of the pad due to the force of gravity. Thus, the top-feed fluid dispenser 58 of the present invention allows for complete saturation of the foam applicator pad 36. This provides for better coverage of the sidewalls 16, 17 of the tires 15 in that a larger amount of tire dressing fluid can be delivered to and retained by the applicator pads 36 of the present invention for application to tires of a vehicle than the prior art applicator pads of the apparatus of the '429 patent. Additionally, the increased capacity of the applicator pad 36 of the present invention without cavities can be an important feature in view of the increasingly larger tires available on current model vehicles.

The present fluid dispenser 58 is an improvement over the prior art tire dressing apparatus disclosed in the above-identified '429 patent, wherein the tire dressing is delivered to a central area of the applicator pad such that fluid is transferred to an upper portion of the applicator pad only via capillary action sufficient to cause the fluid to move against the force of gravity.

Further, the applicator pads 36 of the present invention formed as a block having a generally rectangular cross section are much less expensive to manufacture than the applicator pads of the apparatus of the '429 patent. The present invention applicator pads 36 require only the bolt holes 37 drilled perpendicular to the length of the otherwise generally rectangular shaped applicator pads to receive the bolts 54 for mounting the applicator pad 36 to the frame member 50. Typically, the applicator pads 36 can be drilled at the time of the installation thereof to provide the bolt holes 37 therethrough. Whereas, the above-identified prior art tire dressing applicator requires applicator pads having a plurality of orifices opening through a rear side of the pads for receiving a portion of a spray nozzle in each orifice. Additionally, a longitudinal groove is typically provided in the applicator pads of the prior art apparatus of the '429 patent for receiving a portion of a spray bar therein.

Additionally, because the orifices required in the applicator pads of the prior art apparatus reduce the overall volume of the foam material of the applicator pads, the present invention applicator pads 36, without orifices, will retain substantially more fluid than the prior art applicator pads. For example, the dispenser can be designed as a frame structure instead of a plate and the manifold can be designed as a perforated pipe or closed channel member with a series of holes or small nozzles. The applicator pad 36 can be a sponge or formed from a loosely woven or non-woven textile material such as a mop for ready of the dispensed fluid. Additionally, the manifold may overhang the top plate and dispense the fluid directly downward. Although not shown in the drawings, the contact surface 38 of the applicator pads 36 can define a convex or concave shape to better conform to the shape of the sidewalls 16, 17 of the tires 15 for applying a dressing thereto.

Another advantage of the present invention tire dressing applicator 10 is that the simple design of the top-feed fluid dispenser 58 including the manifold 62 and the top plate 60 of the present invention provides a fluid dispenser that is much less expensive to manufacture than the nozzle assembly of the prior art apparatus of the '429 patent.

The foregoing description of embodiments of the invention have been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. In an apparatus for applying fluid to a tire of a vehicle having an applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from the tire, the improvement comprising:
a manifold for dispensing fluid to the applicator pad, the manifold being disposed proximate an upper surface of the applicator pad and having a plurality of discharge ports for dispensing fluid onto the applicator pad, such that, during use of the apparatus, fluid from the ports is applied to the upper surface of the applicator pad and flows through the applicator pad due to the force of gravity.

2. The apparatus according to claim 1 wherein the manifold is mounted to the frame member for movement with the applicator pad toward and away from the sidewall of a tire.

3. The apparatus according to claim 1 wherein the manifold is disposed such the discharge ports are positioned above the applicator pad when the apparatus is positioned for operation thereof.

4. The apparatus according to claim 1 further comprising a top plate coupled to the frame member, the top plate defining an edge disposed adjacent a length of the upper surface of the applicator pad, the manifold being coupled to the top plate near the edge thereof such that fluid dispensed from the manifold is applied to the upper surface of the applicator pad.

5. The apparatus according to claim 1 wherein the manifold includes a tube defining at least one port through a sidewall thereof for dispensing fluid to the applicator pad through the port.

6. The apparatus according to claim 1 wherein the manifold further comprises a nozzle in fluid communication with at least one of the discharge ports for delivering fluid to the applicator pad through the nozzle.

7. The apparatus according to claim 4 wherein the top plate defines a recess along the edge thereof for receiving the manifold therein.

8. The apparatus according to claim 4 wherein the top plate is coupled to the frame member and the applicator pad is compressed between the top plate and the frame member for securing the applicator pad to the frame member.

9. The apparatus according to claim 4 further comprising means for attaching the manifold to the top plate.

10. The apparatus according to claim 1 wherein the manifold includes at least one fitting for coupling the manifold to a supply line for the fluid.

11. An apparatus for applying fluid to a tire of a vehicle, comprising:
first and second applicator pads having opposed contact surfaces engageable with at least one tire on first and second sides of a vehicle respectively,
first and second frame members carrying said first and second applicator pads, respectively, for movement between an engaged position wherein the contact surfaces engage the tires of a vehicle for applying a fluid thereto, and a disengaged position wherein the contact surfaces are spaced apart from the tires,
means for articulating said first and second frame members between said engaged and disengaged positions, and
a manifold mounted to each of said first and second frame members for dispensing fluid to an upper surface of each of said first and second applicator pads respectively, each of said manifolds disposed proximate an upper surface of said corresponding applicator pad such that, during use of the apparatus, fluid dispensed through the manifolds is applied to the corresponding applicator pad and is absorbed thereby and flows downwardly therethrough.

12. The apparatus for applying fluid to a tire of a vehicle according to claim 9 further comprising a top plate coupled to the each of said first and second frame members for securing said first and second applicator pads, respectively, to said frame members, each said manifold being mounted to one of said top plates.

13. The apparatus for applying fluid to a tire of a vehicle according to claim 10 wherein each said top plate includes an edge thereof disposed adjacent an upper surface of said applicator pad, said manifold being mounted to said top plate such that fluid dispensed therefrom during use of said apparatus, is delivered to said upper surface of said applicator pad and caused to drain through a height of said applicator pad due to the force of gravity on said fluid.

14. The apparatus for applying fluid to a tire of a vehicle according to claim 11 wherein said top plate defines a recess near said edge for receiving said manifold in said recess.

15. The apparatus for applying fluid to a tire of a vehicle according to claim 10 wherein said top plate further comprises means for securing the manifold to said top plate.

16. The apparatus for applying fluid to a tire of a vehicle according to claim 9 wherein said manifold includes a tube defining at least one opening in a sidewall thereof for dispensing said fluid through said opening.

17. The apparatus for applying fluid to a tire of a vehicle according to claim 9 wherein said manifold further comprises a nozzle for delivering fluid to the applicator pad through said nozzle.

18. A top-feed fluid dispenser for use with an apparatus for applying fluid to a tire of a vehicle of the type having an elongated applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from said tire, said fluid dispenser comprising:
a manifold connectable to a fluid supply for dispensing fluid to said applicator pad, said manifold being attachable to said frame member and positioned proximate an upper surface of said applicator pad such that, during use of the apparatus, fluid dispensed through said manifold is applied to said upper surface of said applicator pad and flows through said applicator pad due to the force of gravity.

19. The top-feed fluid dispenser according to claim 16 further comprising a top plate attachable to said frame member such that at least a portion thereof overlies said applicator pad when said apparatus is positioned for use thereof, said manifold being attached to said top plate.

20. A top-feed fluid dispenser according to claim 16 wherein said top plate includes an elongated edge positionable overlying said applicator pad, said top plate defining a recess adjacent said edge for receiving said manifold.

21. A top-feed fluid dispenser according to claim 16 wherein said manifold includes a tube defining at least one port in a sidewall thereof for dispensing said fluid to said applicator pad.

22. A top-feed fluid dispenser according to claim 16 wherein said top plate is attachable to said frame member with said applicator pad compressed between said frame member and said top plate for securing said applicator pad to said apparatus.

23. A kit for modifying an apparatus for applying fluid to a tire of a vehicle of the type having an elongated applicator pad including a contact surface engageable with at least one tire of a vehicle, the applicator pad being mounted to a frame member for movement between an engaged position, wherein the contact surface engages a sidewall of the tire for applying a fluid thereto, and a disengaged position, wherein the contact surface is spaced apart from said tire, said kit comprising:
a top plate attachable to a frame member of the apparatus such that at least a portion thereof overlies said applicator pad when said apparatus is positioned for use thereof; and
a manifold connectable to a fluid supply for dispensing fluid to said applicator pad, said manifold being attachable to said top plate proximate an upper surface of said applicator pad such that, during use of the apparatus, fluid dispensed through said manifold contacts said upper surface of said applicator pad and flows through said applicator pad due to the force of gravity.
